(19) United States
(12) Patent Application Publication
(10) Pub. No.: US 2004/0039925 A1
(43) Pub. Date: Feb. 26, 2004

(54) Key management

(76) Inventors: Craig McMillan, Frekhaug (NO); David Turvey, Ely (GB); Simon Birt, London (GB)

Correspondence Address: B. Noel Kivlin, Meyertons, Hood, Kivlin, Kowert & Goetzel, P.C., P.O. Box 398, Austin, TX, 78767, US

(21) Appl. No.: 10/348,209

(22) Filed: Jan. 21, 2003

(30) Foreign Application Priority Data
Jan. 18, 2002 (GB) 0201144.3

(51) Int. Cl. H04L 9/00

(52) U.S. Cl. 713/189; 713/150; 380/277

(57) ABSTRACT

Disclosed is a mechanism, method and apparatus for providing cryptographic key management. In one example, a cryptographic key management system (100′) includes a plurality of processing mechanisms (140) for receiving data to be signed according one or more signing cryptographic keys. Each processing mechanism (140) is coupled to one or more respective cryptographic key modules, such as a hardware security module (146) configured to store the cryptographic key(s). A network configuration database (144) is accessible by each processing mechanism (140) and stores information identifying the cryptographic key(s) stored in the cryptographic key modules (146).

### BACKGROUND OF THE INVENTION

The present invention relates to key management. Illustrative embodiments relate to, but not exclusively to, key management involving the distribution of private key material amongst nodes in a cluster to create consistent distributed identities.

Although the terms “key” and “cryptographic key”, as referred to in the context of a symmetrical key used in the Data Encryption Standard (DES), and public/private key pairs used in a Public Key Infrastructure (PKI), for example, are clearly related to the field of cryptography, it is understood that these terms are not limited solely to use in this field. The terms “key” and “cryptographic key”, in addition to their conventional meaning, may be used herein to refer to any information which it is necessary to be in possession of or use in order that an operation can be performed in conjunction with corresponding complementary data to the key, to provide a useful result. For example, in cryptography, a key (or cryptographic key) may include data and an encrypted message may be the complementary data to the key (or cryptographic key), the key (or cryptographic key) and complementary data being related to each other by way of a mathematical algorithm. In this cryptography example, the key (or cryptographic key) and corresponding complementary data can be used as inputs into a mathematical algorithm, the resulting operation of which produces a decrypted message as a useful result.

During the last few years, the number of cryptographic operations that need to be performed day-to-day in order to provide security for online transactions has grown enormously. This growth has been driven in large part by an increase in e-commerce, particularly that using the Internet as a communications media. However, this growth in the number of cryptographic operations that must be performed to support online transactions has itself placed a large burden on the existing computing infrastructure, particularly infrastructure specifically designed to handle cryptographically intensive service provision such as, for example, the provision of digital signatures in online certificate validation servers or Certificate Authority (CA) servers. This is because cryptographic operations are computationally intensive, particularly where encryption and/or decryption is being performed using a symmetrical cryptographic key or asymmetrical public/private cryptographic keys having a long bit length as is required for enhanced security.

Certificate Authorities (CAs) are trusted third-party organisations or companies that issue digital certificates that can be used to create digital signatures. They can also issue public-private cryptographic key pairs. The role of the CAs is to help ensure that the individual granted a unique certificate is, in fact, who he or she claims to be. Usually, this means that the CAs have an arrangement with a financial institution, such as a credit card company, which provides it with information to confirm an individual's claimed identity. CAs are a useful component in data security and electronic commerce because they help ensure that two parties exchanging information are really who they claim to be.

One approach to relieving some of the burden placed on computer systems designed to handle cryptographically intensive service provision, such as those referred to above for example, has been to use dedicated cryptographic key modules. For example, commercially available hardware security modules (HSMs) such as the nShield™ HSM available from nCipher™ or the Luna™ XPplus HSM available from Chrysalis-ITS™. HSMs can be connected to computer systems in a cluster to provide accelerated cryptographic processing and protection for cryptographic keys used by the computer systems. The cluster can form a scalable distributed server in which cryptographic operations are distributed for processing among the computer systems in the cluster according to load balancing criteria.

HSMs can be connected in a cluster so that encrypted key material may be transmissible from one HSM to another HSM in the cluster. Copies of encrypted keys can be transferred between HSMs so that the encrypted keys are available at each HSM in the cluster. Conventionally, as a security feature, communication of encrypted key material between HSMs is by way of point to point communication which reduces the amount of time during which key-related material exists in transit outside of the HSMs. For additional security, key-related material, such as, for example, one or more encrypted keys, is also only stored in the HSMs.

A cluster based server is useful for providing a scalable system to provide digital signature services using PKI, as the private cryptographic keys used for signing can be securely held in the HSMs and are only accessible within the secure hardware environment of the HSMs. Private cryptographic keys can be generated and stored locally at an HSM by an administrator for use, for example, in digitally signing and/or certifying data. However, when private cryptographic keys are generated in this way, there may be a time lag between the generation of the private cryptographic key and the private cryptographic key's being identifiable or accessible across the whole of the cluster. This can mean that requests for signing data according to the new private cryptographic key fail if they are sent to a computer system connected to an HSM that has no access to, or is not aware of, the new private cryptographic key. For this reason it may be necessary to take the cluster off-line whilst administration functions are performed, such as for updating access to private cryptographic keys. This also applies to when new cryptographic keys are generated and old cryptographic keys invalidated, as well as to when other cryptographic key changes, such as the modification of hierarchical information or trust relationships, are made.

### SUMMARY OF THE INVENTION

In contrast to conventional systems, aspects of the present invention store cryptographic key-related material outside of the HSMs.

According to a first aspect of the invention, there is provided a cryptographic key management mechanism operable to initiate the application of a cryptographic key to corresponding complementary data in a cryptographic key module. The cryptographic key management mechanism is configured to receive the complementary data, retrieve information corresponding to an encrypted form of the cryptographic key from a network configuration database and dispatch the complementary data and the information corresponding to the encrypted form of the cryptographic key to the cryptographic key module.

According to a second aspect of the invention, there is provided a cryptographic key management mechanism for distributing cryptographic keys in a network. The cryptographic key management mechanism is configured to receive an encrypted cryptographic key from a cryptographic key module and to store information corresponding to the encrypted cryptographic key in a network configuration database.

Cryptographic keys may be private cryptographic keys. They may be securely generated and/or used in one or more hardware security modules. Private cryptographic keys have corresponding complementary public cryptographic keys that may be freely distributed without compromising the integrity of data signed and/or encrypted using the private cryptographic keys. A private cryptographic key may be used for signing the content of a message. Information corresponding to an encrypted cryptographic key may be distributed without unduly compromising the integrity of the cryptographic key, according to one example this information may include the encrypted cryptographic key itself. According to another example, this information may include a part of an encrypted cryptographic key. According to another example, this information may include parts of an encrypted cryptographic key that are distributed about the network. According to another example, the information corresponding to the encrypted cryptographic key may include one or more tokens, such as, for example, pointers, that identify the cryptographic key in a particular cryptographic key module. The encrypted cryptographic key may be obtained by encrypting the cryptographic key using, what is termed herein, a wrapping cryptographic key. In one example, the wrapping cryptographic key is a symmetric cryptographic key held securely in one or more hardware security modules. The encrypted cryptographic key may be decrypted by applying the wrapping cryptographic key in one or more hardware security modules.

The cryptographic key management mechanisms may be configured to maintain at least one configuration version indicator indicating which version of the network configuration database should be used. When an encrypted form of a cryptographic key is needed, the cryptographic key management mechanism may access information corresponding to an encrypted form of the cryptographic key from the network configuration database according to the configuration version indicator. Cryptographic keys may thus be selected for use according to a version, thereby helping to ensure that the latest versions, and possibly also previous versions, are available reliably throughout the network.

According to another aspect of the invention, a cryptographic key management system includes a plurality of processing mechanisms configured to provide an application server including a cryptographic key management mechanism according to any aspect of the invention mentioned herein. The processing mechanisms are each operably coupled to at least one associated cryptographic key module and a network configuration database for storing information corresponding to at least one encrypted cryptographic key.

By using a network configuration database to which all the processing mechanisms have access, the cryptographic key management system can appear as if it were a single processing mechanism that has access to all cryptographic keys. This not only improves the scalability of the cryptographic key management system, but also maintains a secure centralised cryptographic key log that can be backed up and used by a security manager, for example, to check the availability and location of cryptographic keys centrally within what may otherwise be a cryptographic key management system composed of distributed processing mechanisms.

The network configuration database may store version information. The version information can indicate hierarchical relationships between certificates associated with cryptographic keys used to provide certification. During the building of a new configuration by, for example, the addition of new cryptographic keys or the invalidation of old cryptographic keys, a configuration version indicator indicating a previous valid configuration for the cryptographic key management system can be set to instruct the processing mechanisms to handle signing requests based upon the previous valid configuration. Once all operations necessary for the new configuration to become valid have been performed, the configuration version indicator may be updated to instruct the processing mechanisms to use the new configuration. This arrangement helps reduce the possibility that an incoming message for processing, for example, is dispatched to a processing mechanism that does not have access to a cryptographic key needed during processing. This arrangement may therefore help ensure the cryptographic key management system appears as a single operational unit. Without such an arrangement, it is possible that a cryptographic key be created on one cryptographic key module and a request to use that cryptographic key be received at another cryptographic key module before the cryptographic key can be distributed to all the cryptographic key modules in the cryptographic key management system. Furthermore, use of a versioned network configuration database allows previous configuration versions to be archived and subsequently used to “roll-back” the configuration should this be necessary.

The information for identifying the cryptographic key(s) can include tokens. The use of tokens that are recognisable by the cryptographic key modules can reduce the number of cryptographic keys or cryptographic key parts that are stored outside of cryptographic key modules. In a particular embodiment, the cryptographic key modules are HSMs. The use of HSMs provides enhanced security for cryptographic keys and provides acceleration for cryptographic operations, such as digital signature operations. The information identifying the cryptographic keys can include an encrypted part (including the whole) of one or more cryptographic keys. The processing mechanisms can dispatch data to be operated on and the information identifying the cryptographic keys to a cryptographic key module for signing. The cryptographic keys themselves may be encrypted using a symmetrical wrapper cryptographic key, for example, that is used in all of the HSMs. This allows the cryptographic key to be wrapped by the wrapper cryptographic key and either the whole wrapped cryptographic key, or parts of it, distributed outside of the HSM in which the cryptographic key is generated. In this way, cryptographic keys can be securely stored and/or distributed outside of the HSM in which the cryptographic key was generated. This can reduce the amount of storage space needed for cryptographic keys within individual HSMs.

In one embodiment an authorised certificate list may be compiled and include validated public cryptographic keys that can be stored in an application database accessible by all the processing mechanisms. Use of such an authorised certificate list allows the cryptographic key management system to provide a certification and/or validation service by signing only data found in those messages that are recognised and deemed valid. The processing mechanisms can add a version number to a data block incorporating the data to be signed to allow the cryptographic key management system to recognise the configuration used to generate any digital signatures after signing.

According to another embodiment, the cryptographic key management system includes a request distribution mechanism that distributes data to be signed among the processing mechanisms. The request distribution mechanism may distribute incoming messages received from a message source requesting that data be signed to selected processing mechanisms according to load-balancing criteria, such as, for example, based upon current workloads. This provides improved response times for processing signature requests, and provides a scalable cryptographic key management system that can have a high level of reliability and availability.

According to another aspect of the invention, a method of distributing cryptographic keys in a network includes receiving an encrypted cryptographic key from a cryptographic key module and storing information corresponding to the encrypted cryptographic key in a network configuration database. The method according to this aspect of the invention may include method steps corresponding to any of the operational steps used by the cryptographic key management mechanism according to the second aspect of the invention referred to above.

According to another aspect of the invention, a method of initiating the application of a cryptographic key to corresponding complementary data in a cryptographic key module includes receiving the complementary data, retrieving information corresponding to an encrypted form of the cryptographic key from a network configuration database and dispatching the complementary data and the information corresponding to the encrypted form of the cryptographic key to the cryptographic key module. The method according to this aspect of the invention may include method steps corresponding to any of the operational steps used by the cryptographic key management mechanism according to the first aspect of the invention referred to above.

According to another aspect of the invention, a network configuration database is configured to store information corresponding to encrypted forms of one or more cryptographic keys in a cryptographic key management system. The cryptographic keys may be private cryptographic keys. The information corresponding to an encrypted cryptographic key may include at least part of the encrypted cryptographic key itself. The network configuration database can contain information corresponding to the encrypted cryptographic key(s) including one or more tokens that identify the cryptographic key(s) in cryptographic key modules. The cryptographic keys may be encrypted using a wrapping cryptographic key accessible by a plurality of cryptographic key modules, such as, for example, HSMs. The network configuration database may include one or more version configurations.

According to another aspect of the invention, a cryptographic key management system can certify data received in a message from a message source, each message including an identifier identifying a signer and a digital signature. The cryptographic key management system includes a plurality of data processing mechanisms each operably coupled to at least one respective hardware security module, a network configuration database operably coupled to each of the data processing mechanisms, the network configuration database storing information corresponding to at least one private cryptographic key stored by one or more of the hardware security modules. An application database storing public encryption cryptographic keys is operably coupled to each of the data processing mechanisms and a request distribution mechanism is operable to dispatch the data to be signed to a selected one of the data processing mechanisms according to load balancing criteria. Thus, the selected data processing mechanism may be operable to verify the digital signature by decrypting the digital signature using a public encryption cryptographic key stored in the application database corresponding to the signer, and conditional on the signature being valid, to dispatch the data to be certified to a respective hardware security module for signing in the respective hardware security module using a certifying private cryptographic key.

According to another aspect of the invention, there is provided a method of signing data received in a message from a message source in a network, the message including an identifier identifying a signer and a digital signature. The method includes dispatching the message from a request distribution mechanism to a selected one of a plurality of data processing mechanisms according to load balancing criteria and receiving the message at the selected data processing mechanism. The selected data processing mechanism is operably coupled to at least one hardware security module. The digital signature is verified as belonging to the signer by checking the digital signature using a public cryptographic key corresponding to the identifier identifying the signer held in an application database, conditional that there is such a public cryptographic key. A private cryptographic key to use for signing the message is determined, conditional on the digital signature being positively verified, and a network configuration database accessed to determine information corresponding to the private cryptographic key to be used for signing. The data to be signed and the information corresponding to the private cryptographic key is dispatched to a respective hardware security module for signing in the hardware security module using the private cryptographic key.

Any of the methods referred to above, or any of the steps thereof, may be implemented by one or more program elements. One or more of the cryptographic key management mechanisms may form part of an application server for dealing with the generation and/or use of cryptographic keys. The application server may be implemented using program elements including program code that can operate on a processor mechanism in a cryptographic key management system. The program elements may include program code that can be provided as a computer program product on a carrier medium. Illustrative examples of suitable carrier media include one or more selected from: a radio-frequency signal, an optical signal, an electronic signal, a magnetic disc or tape, solid-state memory, an optical disc, a magneto-optical disc, a compact disc (CD) and a digital versatile disc (DVD).

### BRIEF DESCRIPTION OF THE DRAWINGS

Embodiments of the present invention will now be described, by way of example only, with reference to the accompanying drawings where like numerals refer to like parts and in which:

FIG. 1 shows a schematic representation of a network of computer systems that may be used to implement an embodiment of the present invention;

FIG. 2 shows a schematic representation of a computer system that may be used to implement an embodiment of the present invention;

FIG. 3 shows a schematic representation of a network of computer systems according to an embodiment of the present invention;

FIG. 4 shows a schematic representation of a computer system that may be used to implement an embodiment of the present invention;

FIG. 5 shows a logical representation of a cryptographic key management mechanism according to an embodiment of the present invention;

FIG. 6 is a flowchart showing a method of managing private cryptographic keys for signing digital data according to an embodiment of the present invention;

FIG. 7A is a flowchart showing a method of digitally signing data according to an embodiment of the present invention;

FIG. 7B is a continuation of the flowchart of FIG. 7A;

FIG. 8A shows a schematic representation of a message that may be received by cryptographic key management systems or mechanisms according to an embodiment of the present invention; and

FIG. 8B shows a schematic representation of a signed message response that may be generated by cryptographic key management systems or mechanisms according to an embodiment of the present invention.

### DESCRIPTION OF PARTICULAR EMBODIMENTS

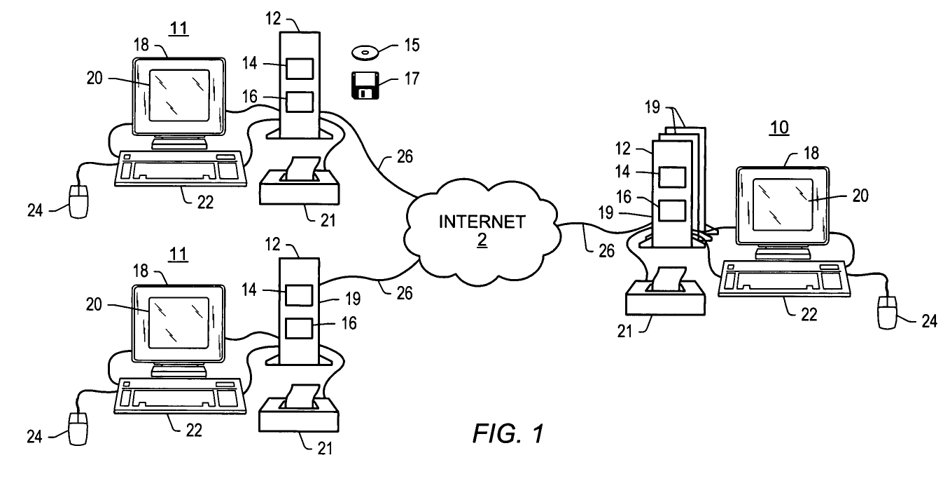

Referring now to FIG. 1, there is illustrated a schematic representation of a network of computer systems, such as the Internet, including a server computer system 10 and client computer systems 11. Both the server computer system 10 and the client computer systems 11 include similar components, for example a system unit 12, a display device 18 with a display screen 20, and user input devices, including a keyboard 22 and a mouse 24. A printer 21 is also connected to the system. Each system unit 12 includes media drives, including an optical disc drive 14, a floppy disc drive 16 and an internal hard disc drive not explicitly shown in FIG. 1. A CD-ROM 15 and a floppy disc 17 are also illustrated. Additionally, server computer system 10 includes high capacity storage media, such as further magnetic hard discs 19, for example.

A computer program for implementing various functions or conveying various information may be supplied on media such as one or more CD-ROMs and/or floppy discs and then stored on a hard disc, for example. The computer system shown in FIG. 1 is also connected through connections 26 to a network 2, which in the illustrated embodiment is the Internet but may be a local or wide area dedicated or private network, for example. The network 2 may provide secure communications though the connections 26. A program implementable by a computer system may also be supplied on a telecommunications medium, for example over a telecommunications network and/or the Internet, and embodied as an electronic signal. For a client computer system 11 operating as a mobile terminal over a radio telephone network, the telecommunications medium may be a radio frequency carrier wave carrying suitably encoded signals representing the computer program and data or information. Optionally, the carrier wave may be an optical carrier wave for an optical fibre link or any other suitable carrier medium for a land line link telecommunication system.

Each computer system 10, 11 has a unique address within the Internet and within the terminology of the World Wide Web (WWW) these addresses are known as Uniform Resource Locators (URLs). Additionally, other resources within the WWW may also have a unique address or URL. A resource entity may include not only different types of processing or storage apparatus, but also one or more of different types of information, for example text, graphics, audio, video etc and such resources may therefore be referred to as hypermedia documents or resources.

WWW software is based on client-server architecture. A web client, for example a browser, is a computer program which can send messages to a web server. These messages may include requests for information or requests to initiate certain tasks, such as transaction processes or requests for validating data by applying a digital signature, for example. Often, for reasons of security, the messages and any responses to the requests therein are dispatched between a client computer system 10 and a server computer system 11 over a secure link, such as one created using a secure sockets layer (SSL) protocol, for example. A web server is a program which sends responses to requests from a client. The web server resides on a server computer system 10. The response received by the client is stored by a client computer system 11, typically on hard disc drive 19. The client program typically resides on hard disc drive 19 of the client computer system 11 and is operable to configure client computer system 11 to interface with the Internet and WWW.

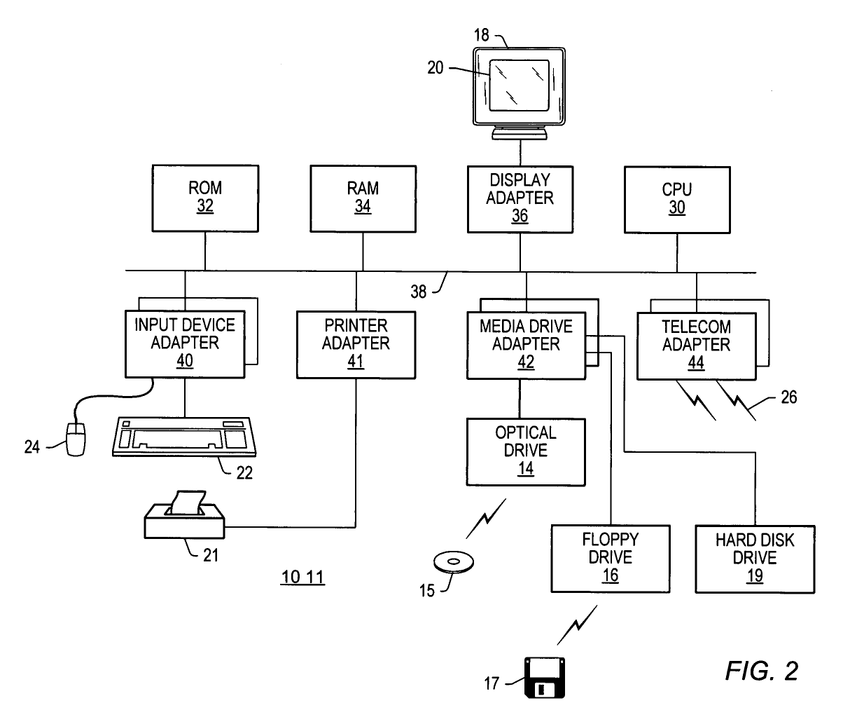

Referring now to FIG. 2, there is shown a schematic and simplified representation of an illustrative implementation of a data processing apparatus in the form of a computer system such as that referred to with reference to FIG. 1. As shown in FIG. 2, the computer system includes various data processing resources such as a processor (CPU) 30 coupled to a bus structure 38. Also connected to the bus structure 38 are further data processing resources such as read only memory 32 and random access memory 34. A display adapter 36 connects a display device 18 to the bus structure 38. One or more user-input device adapters 40 connect the user-input devices, including the keyboard 22 and mouse 24 to the bus structure 38. An adapter 41 for the connection of the printer 21 may also be provided. One or more media drive adapters 42 can be provided for connecting the media drives, for example the optical disc drive 14, the floppy disc drive 16 and hard disc drive 19, to the bus structure 38. One or more telecommunications adapters 44 can be provided thereby providing processing resource interface means for connecting the computer system to one or more networks or to other computer systems. The communications adapters 44 could include a local area network adapter, a modem and/or ISDN terminal adapter, or serial or parallel port adapter etc, as required.

It will be appreciated that FIG. 2 is a schematic representation of one possible implementation of a computer system, suitable for one or more of a server computer system 10 and a client computer system 11. It will be appreciated, from the following description of embodiments of the present invention, that the computer system in which the invention could be implemented may take many forms. For example, rather than the server computer system 10 including a display device 18 and printer 21, it may be merely necessary for the server computer system 10 to include a processing unit, and be accessible by client computer systems 11. The client computer system 11 may also be a non-PC type of computer system which is Internet- or network-compatible, for example a Web TV, or set-top box for a domestic TV capable of providing access to a computer network such as the Internet.

Optionally, the client computer system may be in the form of a wireless personal digital assistant (PDA), wireless application protocol (WAP) enabled telephone or a multimedia terminal.

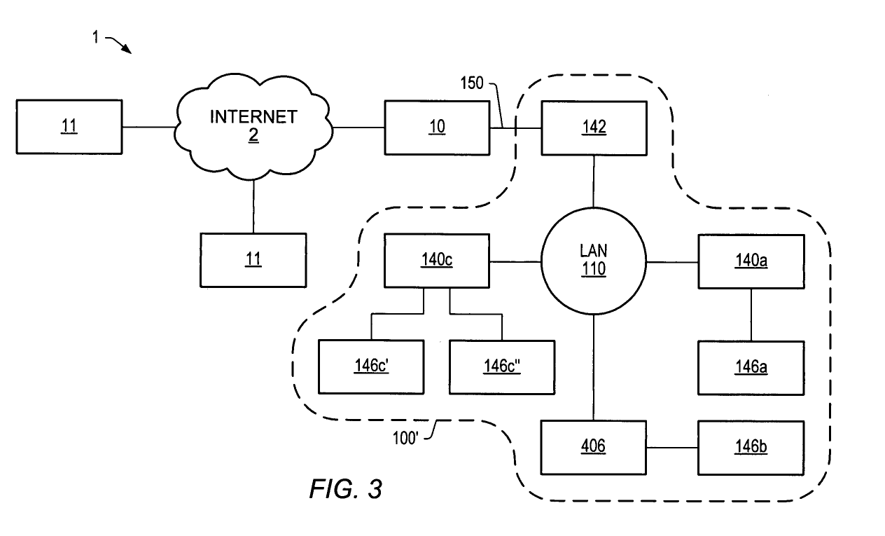

FIG. 3 shows a schematic representation of a network of computer systems 1 according to an embodiment of the present invention. The network of computer systems 1 includes client computer systems 11 coupled through a network 2, such as the Internet, to a server computer system 10. The server computer system 10 operates a web server program that causes the server computer system 10 to act as a firewall between the network 2 and a cryptographic key management system 100′. In an illustrative embodiment, the web server program examines messages from client computer systems 11 to see if they contain requests for digital signature services, such as verifying an existing certificate or signature.

If requests for digital signature services are received in the correct format, the server computer system 10 dispatches the messages through the data link 150 to the cryptographic key management system 100′. The data link 150 may be a physical link between the server computer system 10 and a request distributing mechanism 142, such as, for example, where the request distributing mechanism 142 is a load-balancing router. However, the data link 150 may be a logical link between the server computer system 10 and a request distributing mechanism 142, such as, for example, where the request distributing mechanism 142 is a software services module operating on the server computer system 10.

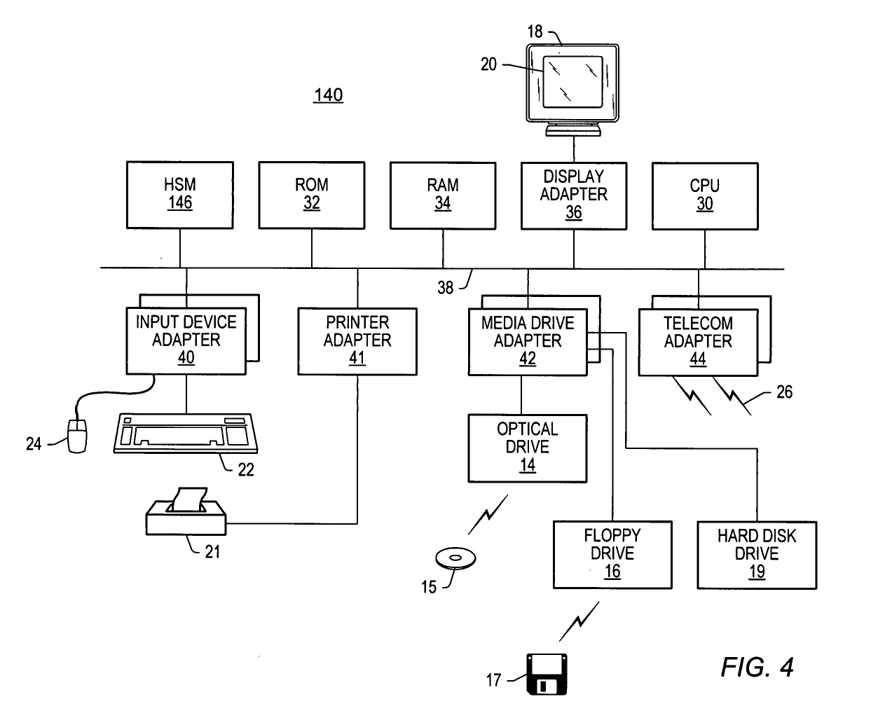

The cryptographic key management system 100′ includes the request distributing mechanism 142 coupled to a private network 110 including a Virtual Private Network (VPN), such as, for example, a local area network (LAN) operating using the TCP/IP protocol. Messages containing requests for digital signature services are distributed over the private network 110 to processing mechanisms 140 (here illustrated by example processing mechanisms 140a, 140b and 140c), configured as a cluster of individually addressable nodes on the private network 110, by the request distributing mechanism 142. Each of the processing mechanisms 140 is coupled to one or more cryptographic key modules, such as, for example, hardware security modules (HSMs) 146, for providing accelerated cryptographic operations, such as cryptographic key generation (e.g. symmetrical or public/private cryptographic key), and enhanced storage security for private cryptographic keys. An example of such a processing mechanism 140 coupled to one such HSM 146, is shown in FIG. 4, and described below.

Processed requests may generate responses that include signed and/or certified data and/or messages indicating why requests cannot be processed. The responses can be generated by the processing mechanisms 140 and/or the HSMs 146. Responses are routed from the processing mechanism 140 handling the request over the private network 110 to the request distributing mechanism 142. The request distributing mechanism 142 then dispatches the responses to the requests to the server computer system 10 for forwarding through the network 2 and back to the respective clients 11 that generated the messages including the corresponding requests.

FIG. 4 shows a schematic representation of a computer system based processing mechanism 140 that can be used in the cryptographic key management system 100′ shown in FIG. 3. The computer system based processing mechanism 140 can be used as an application server. The processing mechanism 140 is similar in construction to the computer system of FIG. 2, and may incorporate the same components as described above in relation to FIG. 2. Additionally, the processing mechanism 140 includes an HSM 146 and can form one node in a cluster of the cryptographic key management system 100′. Other nodes in the cluster may be formed using similar combinations. The HSM 146 is connected to the bus structure 38 of the processing mechanism 140 and communicates with the processor 30 through the bus structure 38. The processor 30 operates cryptographic application program interface (API) software as part of application server software, that can be read from storage on the hard disc drive 19, to enable the processor 30 and the HSM 146 to communicate. Although only one HSM is shown, many such HSM units may be coupled to the same bus structure 38 to enhance the performance of the processing mechanism 140.

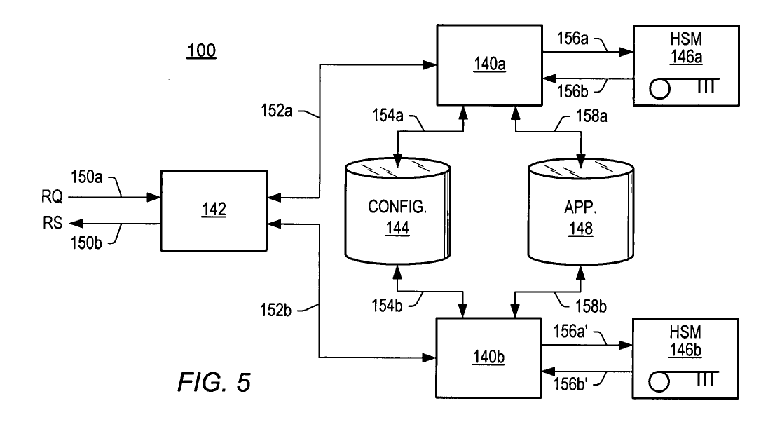

FIG. 5 shows a logical representation of a cryptographic key management mechanism 100 according to an embodiment of the present invention. The cryptographic key management mechanism 100 in accordance with this logical representation may be implemented on hardware elements forming part of a network of computer systems, and more particularly may be implemented on the cryptographic key management system 100′ illustrated in FIG. 3. Optionally, the cryptographic key management mechanism 100 may be implemented using one or more of software, hardware and firmware elements, and is therefore not limited solely to an implementation using the hardware elements shown in FIG. 3.

The cryptographic key management mechanism 100 includes a request distribution mechanism 142 that is configured to receive a message incorporating a request for digital signature services along the request path 150a and dispatch responses to requests along the response path 150b. The cryptographic key management mechanism 100 also includes two processing mechanisms 140a, 140b. The request distribution mechanism 142 is configured to dispatch messages to, and receive responses from, the processing mechanisms 140a, 140b over respective paths 152a, 152b. Each of the processing mechanisms 140a, 140b is further operably coupled to a network configuration database 144, an application database 148 and a hardware security module 146a, 146b. The network configuration database 144, the application database 148 and the hardware security modules 146a, 146b also form part of the cryptographic key management mechanism 100.

The network configuration database 144 is logically distinct from the application database 148, and may be a physically separate unit, and holds system-internal configuration information used to manage private cryptographic keys. The network configuration database 144 can, for example, include a key version database. The network configuration database 144 holds copies of all the private cryptographic keys held in the hardware security modules 146a, 146b, each encrypted by a secure symmetrical wrapping cryptographic key common to all the hardware security modules 146a, 146b in the cryptographic key management mechanism 100. The wrapping cryptographic key can be distributed among the HSMs in the cluster by an m/n share of partial cryptographic key fragments or a vendor implemented secure distribution channel, as known to those skilled in the art of HSMs. The network configuration database holds identifier information corresponding to cryptographic keys and version information indicating which cryptographic keys are available for a particular configuration version and which private cryptographic key should be used to sign at any given trust level. The identifier information can provide a reference to a cryptographic key stored on all hardware security modules 146a, 146b, or can include an encrypted private cryptographic key which may be loaded onto hardware security modules 146a, 146b as required.

It is to be noted that although only two such processing mechanisms 140a, 140b, each coupled to a single respective hardware security module 146a, 146b, are shown, this is merely to aid clarity of the Figure, and it is to be understood that any number of such processing mechanisms may be used coupled to any number of respective, or shared, hardware security modules according to operational requirements.

In one possible scenario, a message containing a request to validate a digital certificate is received by the request distribution mechanism 142. The message includes the digital certificate to be validated (the certificate), and also possibly other content, which may or may not include digital signatures generated by a party requesting validation of the certificate. The certificate includes two parts, the certified content and the signature. The certified content includes the name of the issuer of the certificate (a Certificate Authority or CA), a serial number and expiration date, a public cryptographic key complementary to a private cryptographic key belonging to the owner of the certificate, and the name of the owner of the private cryptographic key complementary to the public cryptographic key. The certified content may, at the option of the issuing authority, contain other data. The signature of the certificate is generated from the certified content by the issuing CA using the private cryptographic key complementary to the public cryptographic key in the issuing CA's own certificate.

The request distribution mechanism 142 maintains information about the processing mechanisms 140 so that it is able to assign a request to a particular processing mechanism 140a, 140b in such a manner as to balance the processing load over the available processing mechanisms 140. The information maintained about the processing mechanisms 140 may be, for example, related to processor load, or it may simply be a list of the available processor mechanisms 140 to which requests can be dispatched in turn.

The assigned processing mechanism 140a, 140b receives the message from the request distribution mechanism 142. At this point the processing mechanism 140a, 140b reads a version indicator from the network configuration database 144, and associates that version indicator with the message. From this point on the message will be processed using the version of the network configuration database content as indicated by the version indicator.

The assigned processing mechanism 140a, 140b extracts the identity of the issuing CA from the certificate to be validated, and determines from the application database 148 whether or not it can determine the validity of the certificate. If the processing mechanism 140a, 140b is not authoritative for certificates issued by the issuing CA of the certificate, a response indicating that the certificate is unknown is prepared. If the processing mechanism is authoritative for the certificate, then the status of the certificate is checked in the application database 148, and a response indicating the status of the certificate is prepared. This response may indicate that the certificate is either valid or invalid.

The processing mechanism 140a, 140b selects a signing cryptographic key according to information held in the network configuration database 144. Signing cryptographic keys can be stored in association with recognised certificates in the application database 148. Cryptographic keys used to sign may be selected according to a recognised certificate associated with a recognised signature attached to the certificate. It is also possible to store identifiers pointing to cryptographic keys stored on HSMs 146 that indicate cryptographic keys stored in one or more of the HSMs 146 that can be used for signing.

A cryptographic key management component operating on the processing mechanism 140a, 140b determines whether the signing cryptographic key is already resident on an HSM 146a, 146b associated with the assigned processing mechanism 140a, 140b. If it is, then that signing cryptographic key can be used without having to supply the signing cryptographic key to the HSM 146a, 146b. If the signing cryptographic key is not available on the associated HSM 146a, 146b, an encrypted version of the signing cryptographic key is loaded onto the HSM 146a, 146b from the network configuration database 144. On HSM 146a, 146b it is decrypted and prepared for use using the cryptographic key (typically a symmetric cryptographic key) resident on the HSM 146a, 146b.

A response, either indicating the validity of the certificate or the inability of the processing mechanism to answer questions concerning the validity of the certificate, is digitally signed by the HSM 146a, 146b using the selected signing cryptographic key. The signature is appended to the response, which is then dispatched to the requester over the response path 150b.

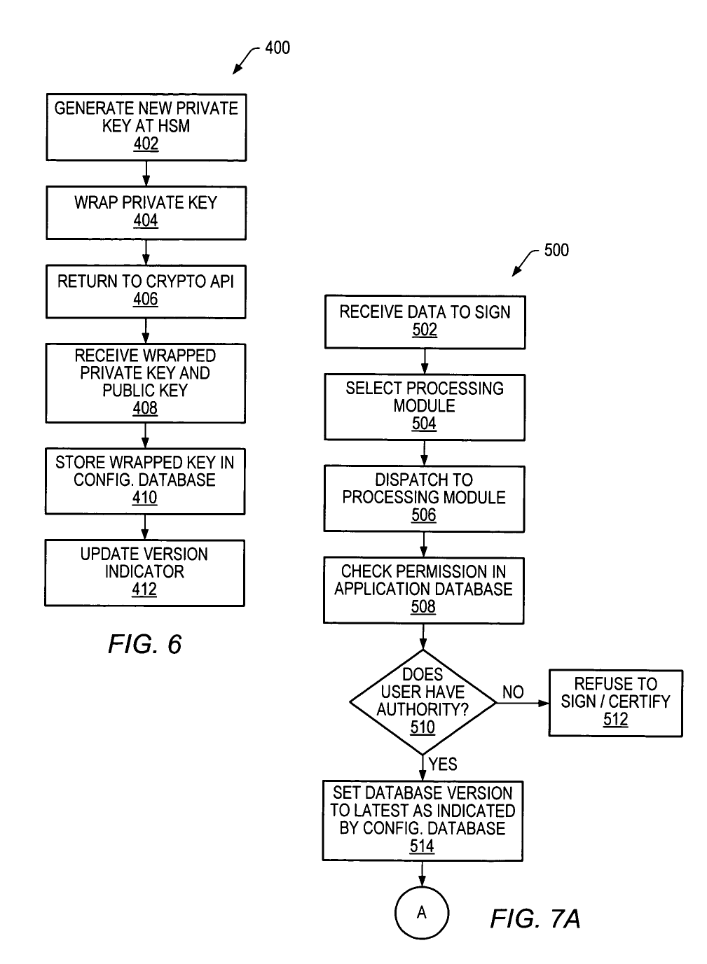

FIG. 6 is a flowchart 400 illustrating a method of managing private cryptographic keys for signing digital data according to an embodiment of the present invention. The method may be implemented by processing steps performed by, for example, a cryptographic key management system 100′, as herein described. At step 402 an administrator instructs the cryptographic key management mechanism or system 100, 100′, through one of the processing mechanisms 140, to generate a new private cryptographic key. The cryptographic key management mechanism or system 100, 100′ selects an HSM 146 for the generation. The administrator may need to present a physical token, such as a smart card, to the HSM in order to verify that he is allowed to perform this operation. The new private cryptographic key is generated securely in the HSM with a corresponding new public cryptographic key using a hardware random number generator, for example.

The HSM wraps the new private cryptographic key, at step 404, by encrypting the new private cryptographic key using, typically, a secure symmetric wrapping cryptographic key held inside the HSM. This allows the private cryptographic key to be exported. Once wrapped, the wrapped private cryptographic key is returned from the HSM 146 to the processing mechanism 140, along with the corresponding public cryptographic key, through a cryptographic API (step 406). The wrapped private cryptographic key is then received with the corresponding public cryptographic key by the processing mechanism, at step 408.

Once the wrapped cryptographic key is received, the processing mechanism 140 builds a new configuration in the network configuration database 144. A record for the wrapped cryptographic key is then stored in the network configuration database 144 along with any information the cryptographic key management mechanism or system 100, 100′ deems appropriate to be associated with the cryptographic key, such as, for example, a CA's certificate. The record is appended to a copy of the records of the previous database, and once the operation is complete the configuration version indicator is updated to point to the new configuration. The newly generated cryptographic key will normally be the subject of a certificate request, which will result in the issuance of a certificate containing the public cryptographic key associated with the newly generated private cryptographic key, and this certificate will be stored in the network configuration database 144 along with the wrapped private cryptographic key.

Although the process of updating a configuration by adding a private cryptographic key has been described, it will be appreciated that configurations can be updated by one or more of, for example, adding cryptographic keys, deleting cryptographic keys, invalidating cryptographic keys, varying permissions, clearance indicators etc.

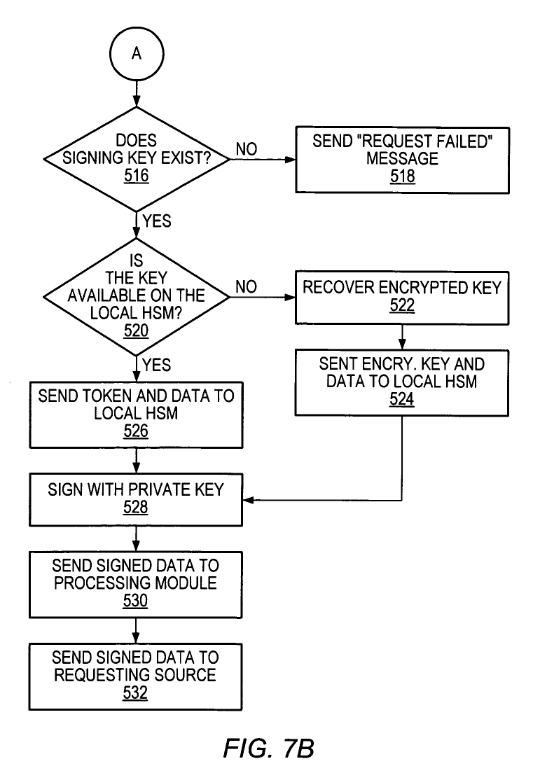

FIGS. 7A and 7B in combination show a method of digitally signing data 500 according to an embodiment of the present invention. At step 502 data to be signed in is received by, for example, a request distribution mechanism. The data to be signed can be part of the message. At step 504 a processing mechanism to process the request is selected, for example by using load balancing criteria as described above. Having selected an appropriate processing mechanism, the content of the message is dispatched to the processing mechanism, at step 506.

At step 508, when the processing mechanism 140 receives the message, it first associates a configuration version indicator with the message. This version indicator determines which version of configuration information stored in the network configuration database 144 will be used when processing the message. The configuration version indicator is fixed whilst processing the request and ensures consistent processing, even though system administrators may be changing system configuration while the message is being processed. The processing mechanism 140 then checks an application database 148 to determine whether the user requesting a digital signature or certificate is authorised to do so. If the user does not have authority to request a digital signature or certificate, such as, for example, where it is determined that no valid digital signature is appended to the request, the user is notified, at step 512, that the request for signature has been refused and may be provided with reasons why this is so. If the user request is valid, the processing mechanism, at step 514, sets a configuration version indicator.

At step 516, the processing mechanism checks the network configuration database 144 to determine whether there is a suitable private cryptographic key for signing or certifying the user's message. If no such cryptographic key exists, or cannot be accessed, the processing mechanism 140 sends a message to the user indicating that the request cannot be processed (step 518). The key may have been removed or be deemed inaccessible if, for example, it has been invalidated, such as, for example, following a time-expiry or key retraction, or if the user does not have the requisite user permissions to access the key. If a suitable cryptographic key is available, a check is performed at step 520 in the network configuration database 144 to determine whether the cryptographic key is available on an HSM 146 local to the processing mechanism, or whether a wrapped version of the cryptographic key needs to be sent from the network configuration database to the local HSM 146 for use in the signing operation. Where the cryptographic key is available locally, the cryptographic key number (or other such token identifying a cryptographic key) is dispatched to the HSM 146 with the data to be signed, which will usually include the whole of the original message (step 526). Where the cryptographic key is not available locally, a wrapped version of the cryptographic key is recovered from the network configuration database 144 (step 522). The wrapped cryptographic key is dispatched to the HSM 146 where it is unwrapped and thereafter ready for use. Then the data to be signed is dispatched (step 524) to the HSM 146 with a cryptographic key identifier identifying the unwrapped key in the HSM 146.

At step 528 the HSM signs the data using the private cryptographic key recovered locally from pre-storage in the HSM or unwrapped in the HSM having been delivered in encrypted form from an external source. At step 530 the signed data is dispatched from the secure environment of the HSM to the processing mechanism. The processing mechanism can then, at step 532, forward the signed data back to the requesting source by creating a response message addressed to the requesting source.

Although the method described above in relation to FIGS. 7A and 7B is one in which the network configuration database 144 maintains records indicating which cryptographic keys are available on which of the HSMs, and only dispatches a wrapped version of the cryptographic key from the network configuration database 144 to a selected HSM 146 if the cryptographic key is not available locally at the HSM 146, other ways of ensuring that the HSMs have access to keys for signing can also be used. The method described above in relation to FIGS. 7A and 7B can be used to complement load-balancing, since when a particular cryptographic key already exists on an HSM that cryptographic key does not need to be unwrapped by the HSM, and so a speedier application of that cryptographic key is made possible.

One way of providing HSMs with access to keys for signing can be for the processing mechanism 140 always to dispatch a wrapped version of the cryptographic key from the network configuration database 144 to a selected HSM 146 regardless of whether or not the cryptographic key is available at any particular HSM 146. This can help reduce the amount of storage space needed in each HSM, as each HSM does not need to store copies of the cryptographic key(s) which it needs to access.

Another way of ensuring that the HSMs have access to keys for signing can be for the processing mechanism 140 to provide a selected HSM 146 with a key identifier, such as, for example, a cryptographic key number (or other such token identifying a cryptographic key), and for the HSM 146 to determine whether the cryptographic key is available internally. Should the cryptographic key not be available, the HSM 146 can then signal to the processing mechanism 140 that a wrapped version of the cryptographic key is to be dispatched from the network configuration database 144 to the HSM 146. This has the added security feature that the network configuration database 144 does not need to maintain a record of which HSMs store which cryptographic key(s).

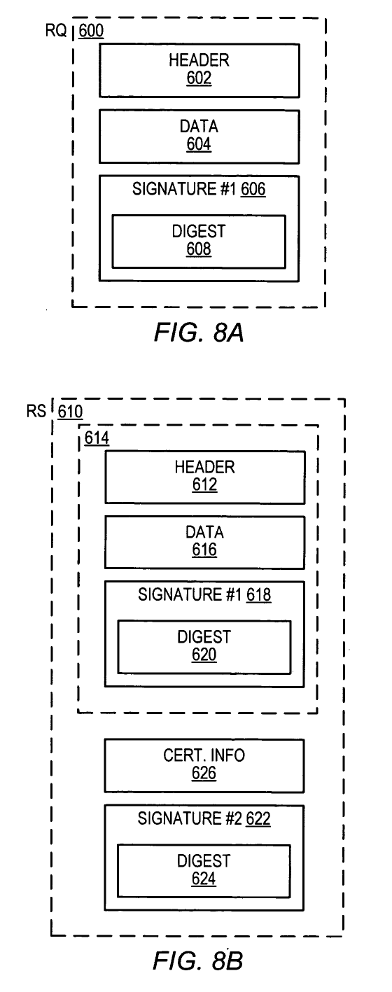

FIG. 8A shows a schematic representation of a message 600 that can be received by cryptographic key management mechanisms or systems 100, 100′ according to an embodiment of the present invention. The relative positions of the data portions contained therein are not necessarily significant. The message 600 can originate from a requesting source remotely located from a cryptographic key management mechanisms or systems 100, 100′ that processes the message 600.

The message 600 includes a header 602. The header 602 may contain information that may be in plain text form and so be easily accessible to any parties that receive or intercept the message 600, such as, for example, information identifying the user and optionally the user's public signing cryptographic key. The header 602 can contain digital certificates issued by one or more CAs themselves containing digital signatures. The header may also contain information relating to the type of signature service that the user is requesting, such as, for example, a particular level of authorisation sought or a particular signature. The message 600 optionally includes data 604. If a user is merely seeking a signature or certificate for information contained in the header, such as, for example, certification of his own identity, then the data 604 may be absent. The data 604 can include any content and may itself be encrypted. For example, the data 604 may include an encrypted text document including confidential financial information encrypted using the user's private encryption cryptographic key.

The message 600 additionally includes a signature 606 generated by the user. To generate the signature 606, the user generates a message digest, or hash, 608 using a standard algorithm such as, for example, the Secure Hashing Algorithm SHA-1, using the header 602 and any data 604 as input to the algorithm. The message digest 608 is signed by the user's private signing cryptographic key to generate the digital signature 606.

FIG. 8B shows a schematic representation of a signed message response 610 that can be generated by cryptographic key management mechanisms or systems 100, 100′ according to an embodiment of the present invention. The relative positions of the data portions contained therein are not necessarily significant.

The message response 610 includes a request 614 originating from a message source. The request 614 may take the form shown in the message 600, described above in connection with FIG. 8A. The message response 610 includes a digital signature 622 applied following authentication of the message response 610 by a cryptographic key management mechanism or system 100, 100′. To generate the signature 622, a message digest, or hash, 624 is generated by inputting the request 614, and optionally certificate information 626 corresponding to the signature provider, into a standard hashing algorithm such as, for example, SHA-1. The message digest 624 is signed by one of the signature provider's private signing cryptographic keys to generate the digital signature 622. Optionally a certificate including certificate information 626 certifying the private cryptographic key used to generate signature 622 forms part of the message response 610, although it is to be understood that it is possible to sign the request 614 without providing such a certificate.

From the foregoing description and associated Figures, it can be seen how cryptographic key management mechanisms and systems according to embodiments of the present invention can be implemented so as to provide a scalable cluster for performing accelerated cryptographic processing. By storing cryptographic key material and/or tokens identifying cryptographic key material outside of the HSMs a scalable cluster for performing accelerated cryptographic processing that does not need to be taken off-line in order to perform administration tasks, such as key changes, can be created. By breaking the paradigm that conventionally good security is achieved by having cryptographic key material stored only in HSMs, cluster security actually can be improved, since the cluster's administrator can make more frequent key updates/changes without unduly affecting the availability and/or reliability of the cluster.

Insofar as embodiments of the invention described above are implementable, at least in part, using a software-controlled programmable processing device such as a Digital Signal Processor, microprocessor, other processing devices, data processing apparatus or computer system, it will be appreciated that a computer program for configuring a programmable device, apparatus or system to implement the foregoing described methods is envisaged as an aspect of the present invention. The computer program may be embodied as source code and undergo compilation for implementation on a processing device, apparatus or system, or may be embodied as object code, for example. The skilled person would readily understand that the term computer system in its most general sense encompasses programmable devices such as referred to above, and data processing apparatus and firmware embodied equivalents.

Suitably, the computer program is stored on a carrier medium in machine or device readable form, for example in solid-state memory, magnetic memory such as disc or tape, optically or magneto-optically readable memory, such as compact disc read-only or read-write memory (CD-ROM, CD-RW), digital versatile disc (DVD) etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

Although the invention has been described in relation to the preceding example embodiments, it will be understood by those skilled in the art that the invention is not limited thereto, and that many variations are possible falling within the scope of the invention. For example, methods for performing operations in accordance with any one or combination of the embodiments and aspects described herein are intended to fall within the scope of the invention. As another example, message and response paths may be implemented using any available mechanisms, including mechanisms using of one or more of: wired, WWW, LAN, Internet, WAN, wireless, optical, satellite, TV, cable, microwave, telephone, cellular etc. The message response and delivery paths may also be secure links. For example, the message response and delivery paths can be secure links created over the Internet using Public Cryptographic key Encryption techniques or as an SSL link.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A cryptographic key management mechanism operable to initiate the application of a cryptographic key to corresponding complementary data in a cryptographic key module, wherein the cryptographic key management mechanism is configured to:
receive the complementary data;
retrieve information corresponding to an encrypted form of the cryptographic key from a network configuration database; and
dispatch the complementary data and the information corresponding to the encrypted form of the cryptographic key to the cryptographic key module.

2. A cryptographic key management mechanism for distributing cryptographic keys in a network, wherein the cryptographic key management mechanism is configured to receive an encrypted cryptographic key from a cryptographic key module and to store information corresponding to the encrypted cryptographic key in a network configuration database.

3. The cryptographic key management mechanism of claim 1, wherein the cryptographic key is a private cryptographic key of a private/public cryptographic key pair.

4. The cryptographic key management mechanism of claim 1, wherein the information corresponding to the encrypted cryptographic key includes the encrypted cryptographic key itself.

5. The cryptographic key management mechanism of claim 1, wherein the information corresponding to the encrypted cryptographic key includes one or more tokens that identify the cryptographic key in the cryptographic key module.

6. The cryptographic key management mechanism of claim 1, wherein the cryptographic key module is a hardware security module.

7. The cryptographic key management mechanism of claim 6, wherein the cryptographic key is encrypted and/or decrypted using a wrapping cryptographic key in the hardware security module.

8. The cryptographic key management mechanism of claim 1, wherein the cryptographic key management mechanism is further configured to maintain at least one configuration version indicator indicating which version of the network configuration database is to be used.

9. The cryptographic key management mechanism of claim 1, wherein the cryptographic key management mechanism is further configured to retrieve the information corresponding to an encrypted form of the cryptographic key from the network configuration database dependent upon a configuration version indicator.

10. An application server including the cryptographic key management mechanism according to claim 1.

11. A program element including program code operable to implement the cryptographic key management mechanism according to claim 1.

12. A computer program product on a carrier medium, said computer program product including the program element of claim 11.

13. A computer program product on a carrier medium, said computer program product including program code operable to:
retrieve an encrypted cryptographic key from a cryptographic key module; and
store information corresponding to the encrypted cryptographic key in a network configuration database.

14. A computer program product on a carrier medium, said computer program product including program code operable to:
retrieve complementary data associated with a cryptographic key;
retrieve information corresponding to an encrypted form of the cryptographic key from a network configuration database; and
dispatch the complementary data and the information corresponding to the encrypted form of the cryptographic key to a cryptographic key module.

15. The computer program product of claim 13, wherein the carrier medium includes a one of the following set of media: a radio-frequency signal, an optical signal, an electronic signal, a magnetic disc or tape, solid-state memory, an optical disc, a magneto-optical disc, a compact disc and a digital versatile disc.

16. A cryptographic key management system for managing cryptographic key distribution and application in a network, including:
a plurality of processing mechanisms configured to provide an application server according to claim 10 and operably coupled to at least one associated cryptographic key module; and
a network configuration database operably coupled to the processing mechanisms for storing information corresponding to at least one encrypted cryptographic key.

17. The cryptographic key management system of claim 16, further including an application database operably coupled to the processing mechanisms for storing user information and/or complementary information corresponding to said at least one encrypted cryptographic key.

18. The cryptographic key management system of claim 16, wherein said at least one cryptographic key module includes at least one respective hardware security module.

19. The cryptographic key management system of claim 16, further including a request distribution mechanism configured to distribute messages among the plurality of processing mechanisms.

20. A method of distributing cryptographic keys in a network, including
receiving an encrypted cryptographic key from a cryptographic key module; and
storing information corresponding to the encrypted cryptographic key in a network configuration database.

21. The method of claim 20, wherein storing information corresponding to the encrypted cryptographic key includes storing the encrypted cryptographic key itself.

22. The method of claim 20, wherein storing information corresponding to the encrypted cryptographic key includes storing one or more tokens that identify the cryptographic key in the cryptographic key module.

23. The method of claim 20, including updating a configuration version indicator in the network configuration database.

24. A method of initiating the application of a cryptographic key to corresponding complementary data in a cryptographic key module, including:
receiving the complementary data;
retrieving information corresponding to an encrypted form of the cryptographic key from a network configuration database; and
dispatching the complementary data and the information corresponding to the encrypted form of the cryptographic key to the cryptographic key module.

25. The method of claim 24, wherein retrieving information corresponding to the encrypted form of the cryptographic key includes retrieving the encrypted cryptographic key from the network configuration database.

26. The method of claim 24, wherein retrieving information corresponding to the encrypted form of the cryptographic key includes retrieving an identifier that identifies the cryptographic key in the cryptographic key module.

27. The method of claim 24, wherein retrieving the information corresponding to the encrypted form of the cryptographic key from the network configuration database is dependant upon a configuration version indicator.

28. A network configuration database configured to store information corresponding to encrypted forms of one or more cryptographic keys in a cryptographic key management system.

29. The network configuration database of claim 28, wherein the cryptographic keys are private cryptographic keys of private/public cryptographic keys pairs.

30. The network configuration database of claim 28, wherein the information corresponding to the encrypted cryptographic key includes the encrypted cryptographic key itself.

31. The network configuration database of claim 28, wherein the information corresponding to the encrypted cryptographic key includes one or more tokens that identify cryptographic keys in cryptographic key modules.

32. The network configuration database of claim 28, wherein the cryptographic keys are encrypted using a wrapping cryptographic key accessible by a plurality of hardware security modules.

33. The network configuration database of claim 28, further including one or more version configurations.

34. A cryptographic key management system for certifying data received in a message from a message source, each message including an identifier identifying a signer and a digital signature, the cryptographic key management system including:
a plurality of data processing mechanisms each operably coupled to at least one respective hardware security module;
a network configuration database operably coupled to each of the data processing mechanisms, the network configuration database storing information corresponding to at least one private cryptographic key stored by one or more of the hardware security modules;
an application database storing public encryption cryptographic keys operably coupled to each of the data processing mechanisms; and
a request distribution mechanism operable to dispatch the data to be signed to a selected one of the data processing mechanisms according to load balancing criteria;
wherein the selected data processing mechanism is operable to verify the digital signature by decrypting the digital signature using a public encryption cryptographic key stored in the application database corresponding to the signer, and conditional on the signature being valid, to dispatch the data to be certified to a respective hardware security module for signing in the respective hardware security module using a certifying private cryptographic key.

35. A method of signing data received in a message from a message source in a network, the message including an identifier identifying a signer and a digital signature, the method including:
dispatching the message from a request distribution mechanism to a selected one of a plurality of data processing mechanisms according to load balancing criteria;
receiving the message at the selected data processing mechanism, the selected data processing mechanism being operably coupled to at least one hardware security module;
verifying that the digital signature belongs to the signer by checking the digital signature using a public cryptographic key corresponding to the identifier identifying the signer held in an application database, conditional that there is such a public cryptographic key;
determining a private cryptographic key to use for signing content of the message, conditional that the digital signature is positively verified;
accessing a network configuration database to determine information corresponding to the private cryptographic key to be used for signing; and
dispatching the data to be signed and the information corresponding to the private cryptographic key to a respective hardware security module for signing in the hardware security module using the private cryptographic key.

36. A key manager for initiating the application of a key to corresponding complementary data in a key module, wherein the key manager comprises:
means for receiving the complementary data;
means for retrieving information corresponding to an encrypted form of the key from a network configuration database; and
means for dispatching the complementary data and the information corresponding to the encrypted form of the key to the key module.

37. A key manager for distributing keys in a network, wherein the key manager comprises means for receiving an encrypted key from a key module and means for storing information corresponding to the encrypted key in a network configuration database.

38. A method of distributing keys in a network, including:
the step of receiving an encrypted key from a key module; and
the step of storing information corresponding to the encrypted key in a configuration database.

39. A method of initiating the application of a key to corresponding complementary data in a key module, including:
the step of receiving the complementary data;
the step of retrieving information corresponding to an encrypted form of the key from a database; and
the step of dispatching the complementary data and the information corresponding to the encrypted form of the key to the key module.

40. A key management system for certifying data received in a message from a message source, each message including an identifier identifying a signer and a digital signature, the key management system including:
a plurality of data processing means each coupled to at least one respective hardware security module means;
a configuration database means operably coupled to each of the data processing means, the configuration database means storing information corresponding to at least one private key stored by one or more of the hardware security module means;
an application database means storing public encryption keys operably coupled to each of the data processing means; and
a request distribution means for dispatching the data to be signed to a selected one of the data processing means according to load balancing criteria;
wherein the selected data processing means is operable to verify the digital signature by decrypting the digital signature using a public encryption key stored in the application database means corresponding to the signer, and conditional on the signature being valid, to dispatch the data to be certified to a respective hardware security module means for signing in the respective hardware security module means using a certifying private key.

41. A method of signing data received in a message from a message source in a network, the message including an identifier identifying a signer and a digital signature, the method including:
the step of dispatching the message from a request distribution means to a selected one of a plurality of data processing means according to load balancing criteria;
the step of receiving the message at the selected data processing means, the selected data processing means being operably coupled to at least one hardware security module;
the step of verifying that the digital signature belongs to the signer by checking the digital signature using a public key corresponding to the identifier identifying the signer held in an application database, conditional that there is such a public key;
the step of determining a private key to use for signing content of the message, conditional that the digital signature is positively verified;
the step of accessing a configuration database to determine information corresponding to the private key to be used for signing; and
the step of dispatching the data to be signed and the information corresponding to the private key to a respective hardware security module for signing in the hardware security module using the private key.
